(19) United States
(12) Patent Application Publication
(10) Pub. No.: US 2003/0156317 A1
(43) Pub. Date: Aug. 21, 2003

(54) Communications network architecture

(76) Inventors: Frank Friedrich Ruhl, Victoria (AU); Trevor Bruce Anderson, Cammeray (AU)

Correspondence Address: Michael A Kaufman, Dorsey & Whitney, Four Embarcadero Center, Suite 3400, San Francisco, CA, 94111-4187, US

(21) Appl. No.: 10/221,411

(22) PCT Filed: Mar. 9, 2001
(86) PCT No.: PCT/AU01/00264

(30) Foreign Application Priority Data
Mar. 10, 2000 (AU) PQ6175

(51) Int. Cl. H04B 10/12

(52) U.S. Cl. 359/341.1

(57) ABSTRACT

A communications network (2) including a number of optical fibre loops (8) having respective access nodes (10), an optical wavelength group for traffic within the loop, and at least one other optical wavelength group for traffic to the another loop. The network (2) has an optical cross-connect (4) for routing traffic between the loops by selecting the wavelength groups. The optical cross-connect (4) is passive, and the network (2) may be a metropolitan area network with traffic being carried by WDM signals.

The present invention relates to a communications network, and in particular to an architecture for a metropolitan area network using optical fibre loops.

The metropolitan area networks of large communications networks, for example the public switched telephone network (PSTN), generally adopt a Synchronous Digital Hierarchy (SDH) ring architecture which has local switching nodes or exchanges in the network connected by respective optical fibre loops which are routed by digital cross-connects (DXCs) at main exchanges. In data-oriented networks, cross-connects may be provided by data switches or routers, such as ATM switches and IP routers, instead of the DXCs. The DXCs of the main exchanges are used to switch traffic between the local fibre loops and also between the local fibre loops and loops or exchanges in other areas, such as interstate or overseas. This requires optical-electrical-optical signal conversion for local connections. In Melbourne for example, a number of main exchanges are maintained in the central business district, and these main exchanges are part of optical fibre loops which connect to local exchanges in the suburbs of Melbourne, such as a loop which includes the Dandenong and Oakleigh exchanges. Melbourne also has a few dozen local access sites and each loop typically has two or three local access sites.

Traffic demands on networks, however, have increased to such an extent that a cost effective solution is required to meet the demand. Simply adding additional optical fibre cable to the loops is one possible solution, but this places additional demand on the DXCs of the main exchanges and pressure on the available space in the duct and conduits which hold the fibre cable. Optical-electrical-optical signal conversion is also inherently costly and inefficient.

Another possible solution is to reduce the demand on the main exchanges by transferring the switching load to the local loops. This can be achieved by increasing the loop sizes to add more exchanges in the loops, and using techniques. such as wavelength division multiplexing (WDM), to facilitate switching between the local nodes in the loops. Larger WDM optical rings give rise to a reduced number of optical loops that need to be switched at the main exchanges, and accordingly reduce the switching load on the main exchanges. However, these large loops require optical amplifiers to cater for losses on the increased loop length. For medium traffic capacities, a cost effective solution favours a passive architecture without amplifiers.

A network architecture is desired which addresses the above problems or at least provides a useful alternative.

In accordance with the present invention there is provided a communications network, including:

a plurality of optical fibre loops each having respective access nodes included in the loops, an optical wavelength group for traffic within the loop, and at least one other optical wavelength group for traffic to at least one other loop; and

an optical cross-connect for routing traffic between the loops by selecting said wavelength groups.

Advantageously, the groups may either be a continuous wavelength band containing several distinct wavelength channels, or a periodic series of wavelength channels.

Preferably the loops support WDM communications signals and the network has at least one hub node provided by the optical cross-connect and the access nodes each include an optical add-drop multiplexer. Advantageously, the optical cross-connect may be passive.

Preferred embodiments of the present invention are hereinafter described, by way of example only, with reference to the accompanying drawings, wherein:

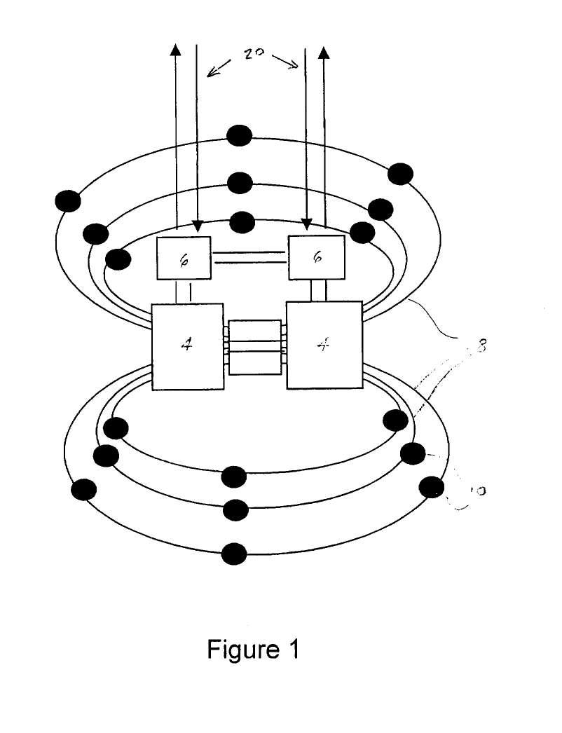

FIG. 1 is a block diagram of a preferred embodiment of a metropolitan area communications network;

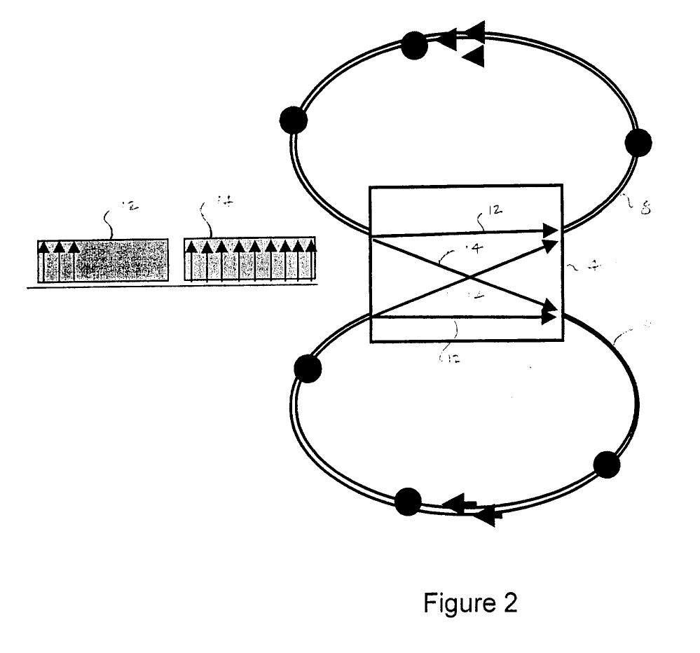

FIG. 2 is a block diagram of interconnection between two loops of the network;

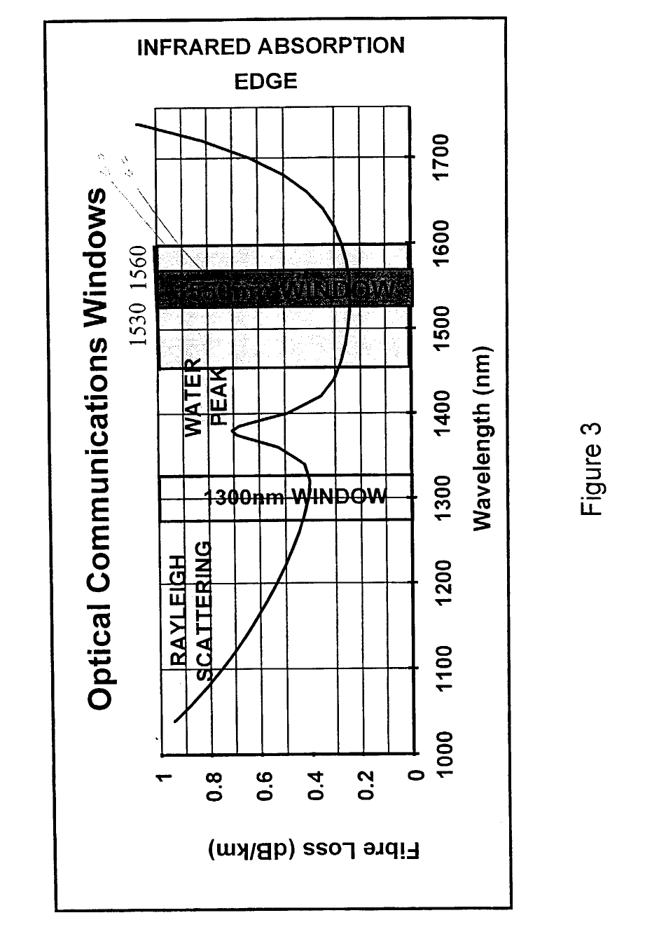

FIG. 3 is a graph of useful wavelengths for optical communications with and without optical amplifiers;

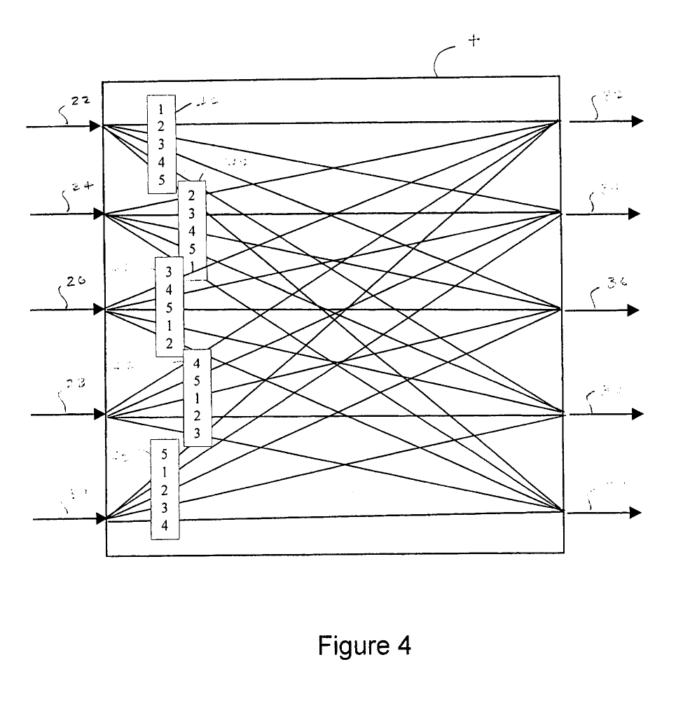

FIG. 4 is a diagram of a connection matrix of an optical router of the network;

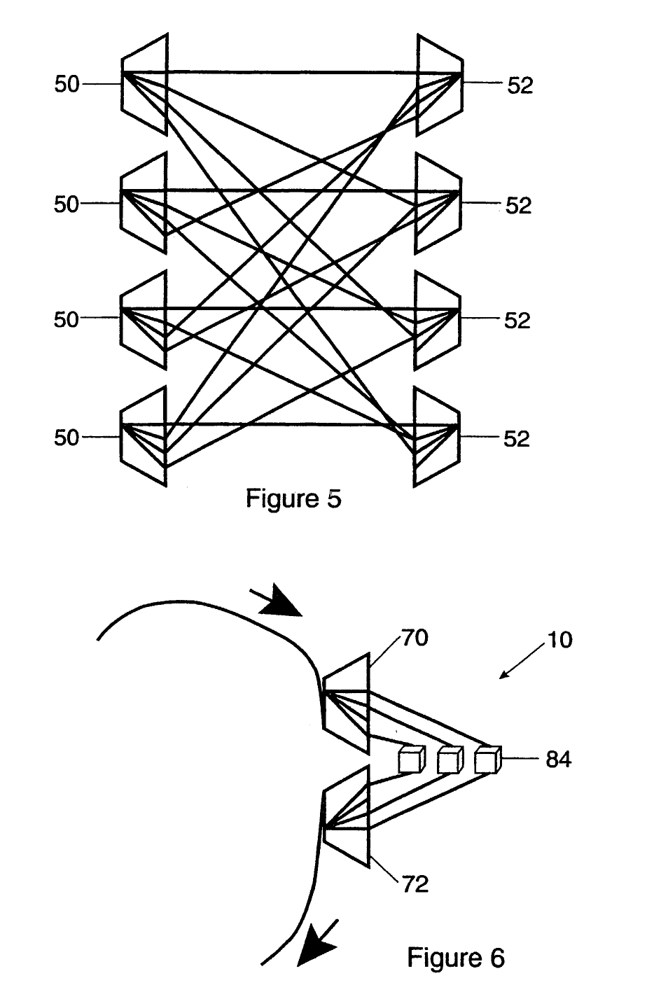

FIG. 5 is a diagram of an optical router of the network having multiplexer/demultiplexer pairs;

FIG. 6 is a diagram of a first implementation of an optical add-drop multiplexer of a node of the network;

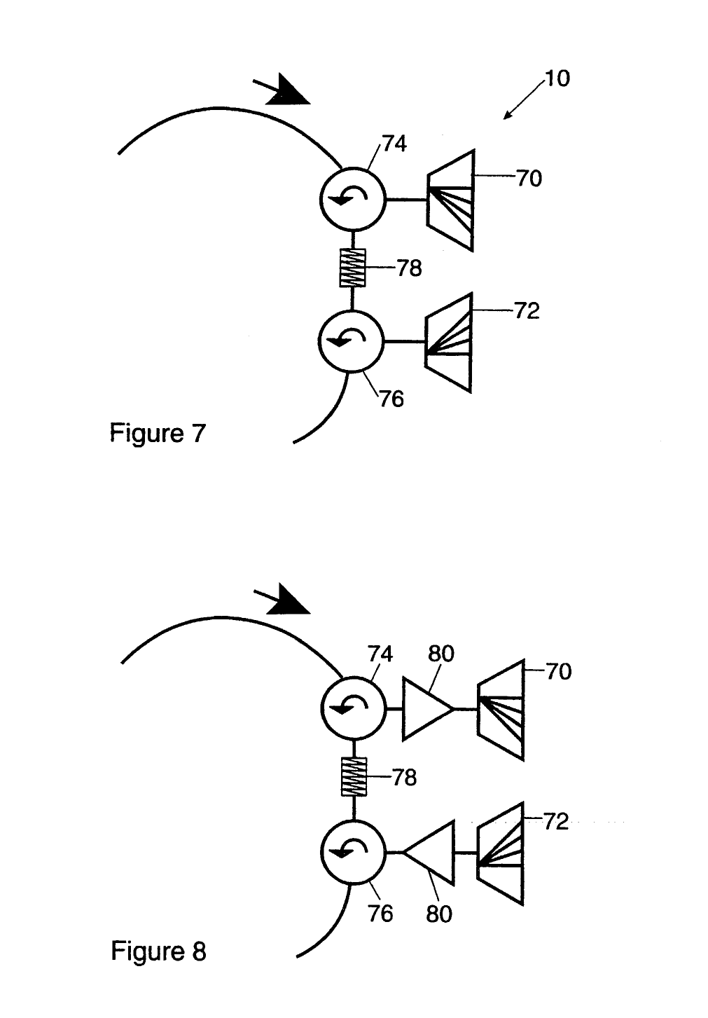

FIG. 7 is a second implementation of an optical add-drop multiplexer of the network; and

FIG. 8 is a third implementation optical add-drop multiplexer of the network.

A metropolitan area communications network 2, as shown in FIG. 1, includes two optical cross-connects 4, two DXCs 6 and a plurality of optical fibre loops 8 connected to ports of the optical cross-connects 4. The loops 8 each include N local access nodes 10 and comprise two optical fibre rings that support bidirectional traffic and protection using either shared or dedicated channel protection schemes. The schemes may be SDH or SONET schemes or their optical equivalent. For instance, the loops can include two optical fibres for connecting the nodes 10. The optical cross-connects 4 may be connected to respective fibres of each loop, such that one cross-connect 4 handles traffic on one fibre, whereas the other optical cross-connect handles traffic travelling on the other fibre. Alternatively, both fibres may be connected to both optical cross-connects 4. This dual hub structure of the network 2 provides significant communications protection in the event of a failure in the network 2, as discussed below.

Traffic on a loop 8 is carried by one or more wavelength division multiplexed (WDM) channels that are partitioned into distinct groups of wavelengths. Traffic between a particular pair of loops 8, as shown in FIG. 2, is allocated a wavelength group 14. A wavelength group 12 is also allocated to internal traffic on a loop 8. The number of groups carried on each loop is equal to the total number of loops 8 in the network 2. Also by using the connection matrix 18 provided by an optical cross-connect 4, as described below, the wavelength groups can be reused to provide connections between different pairs of loops. This reuse of the wavelengths allows the total number of groups required in the network 2 to be equal to the total number of loops. The individual channels within each group used to carry the traffic are accessed by optical add-drop multiplexers of each access node 10. For three access nodes 10 per loop 8, a total of 3×3=9 channels for a inter-loop wavelength group 14 between loops and three channels for the intra-loop wavelength group 12 of a loop provides full point to point connectivity between all access nodes. Accordingly, for an eighteen access node network 2, as shown in FIG. 1, a total of 5×9+3=48 wavelength channels are required for full point to point connectivity within the network. If the number of nodes on a loop is reduced to 2 or 1, then the total number of channels for point to point connectivity for this network 2 reduces to 34 and 18, respectively. Alternatively, SDH or SONET sub-rings can be used to connect several of the nodes 10, thereby further reducing the number of wavelengths required. Accordingly by restricting the loops 8 to no more than 6 nodes, the number of wavelengths which need to be employed is significantly reduced, in addition to reducing losses on the loops and the need to employ additional optical components, such as optical amplifiers. Optical communication wavelengths which can be used are illustrated in FIG. 3. For example, for a 200 GHz channel spacing a passive network has a useful wavelength window 60 of ˜150 nm whereas an active network is typically limited to a window 62 of 30 nm.

The optical cross-connects 4 are connected to the DXC switches 6 which have communications lines 20 that connect the network 2 to other metropolitan area or regional networks, which may be located interstate or overseas. Traffic from or for the lines 20 is allocated its own additional wavelength group on the loops 8. As another alternative, depending on traffic volume, additional fibre can be included in the loops 8 dedicated to handle traffic for the digital cross-connects 6. A further alternative is to drop the traffic from a loop 8 to a DXC switch 6 via an optical add-drop multiplexer (OADM) connected to an optical router 4.

The optical cross-connects 4 are passive wavelength routers which provide full non-blocking connectivity between the loops 8. For instance, the optical cross-connects 4 provide a connection matrix 18, as shown in FIG. 4, for interconnecting five loops. The loops 8 are allocated input ports 22 to 30 and output ports 32 to 40, respectively. All wavelength channels within a wavelength group on a particular input port are routed to the same output port. For instance, wavelength groups 1 and 2 on input port 22 are routed to output ports 32 and 34, respectively. By reusing the same wavelength groups to connect different pairs of loops, the total number of wavelength groups required to provide full connectivity is equal to the number of loops. For example, as shown in FIG. 4, wavelength group 2 connects the loop on input port 22 to the loop on input port 34, the loop on input port 24 to output port 32, the loop on input port 26 to the loop on output 40, and the loop on input port 30 to the loop connected to output port 36. Wavelength group 2 also carries the intra-loop traffic for the loop connected to input port 28 and output port 38. As will be understood by those skilled in the art, a variety of different permutations are available to provide full connectivity for five loops 8 with five wavelength groups.

The optical cross-connect 4 may be advantageously provided by an Arrayed Waveguide Grating (AWG) which is able to act as an N×N router to interconnect N loops 8. An AWG is described in detail in C Dragone, C A Edwards, and R C Kistler, “Integrated optics N×N multiplexer on Silicon,” Photon. Technol. Lett., vol 3, pp 896-899, 1991, herein incorporated by reference. A wavelength group may consist of wavelength channels in a continuous wavelength band. For example, the AWG may have broad flat passbands which cover each wavelength group. Alternatively, a periodicity feature of the AWG may be utilised whereby channels separated by multiple numbers of the free spectral range (fsr) of the AWG are routed in the same manner. In other words a wavelength group j may consist of channels, fsr+j, 2fsr+j, etc. routed in the same manner, provided j≦fsr, and a group k will consist of channels k, k+fsr, k+2fsr, etc., provided k≦fsr.

Alternatively, the optical cross-connect 4 may be implemented using a N×N meshed interconnection of optical multiplexer and demultiplexer pairs, as shown in FIG. 5, where a demultiplexer 50 is provided for each input port 22 to 30, and a multiplexer 52 is provided for each output port 32 to 40.

The digital cross-connects 6 and the local access nodes 10 may be provided by standard telecommunications equipment. For instance, the nodes 10 may include Synchronous Digital Hierarchy (SDH) or Synchronous Optical Network (SONET) add-drop multiplexers to connect to the optical fibres of the loops 8 and have optical filters to extract the respective channels for a node 10. However, finer bandwidth optical filters would be used at the nodes 10 to select the individual wavelength channels from the broader wavelength bands routed by the optical cross-connects 4. The nodes can also be configured to be easily adjusted for different connections by incorporating wavelength tunable transmitters and wavelength reconfigurable filters to cater for additional switch connections added at the nodes 10. The nodes 10 may be a local telecommunications exchange or a node for customer premises if justified by traffic requirements. For SDH services only, the optical add-drop multiplexer (OADM) for a node 10 can be constructed from two AWGs to provide the drop port 70 and add ports 72 for the node 10, as shown in FIG. 6. In the special case, where only SDH or SONET services are provided and all wavelengths are being dropped at every node 10 (ie no wavelength grooming of SDH/SONET add-drop multiplexers (ADMs) 84 is required), the fibre loop can be broken at the access node 10. In this case, the optical add drop multiplexer (OADM) can consist simply of a pair of WDM multiplexers 70 and demultiplexers 72 as shown in FIG. 6. To support point-to-point links, the OADM for a node 10 can be configured, as shown in FIG. 7, by including optical circulators 74 and 76 for the drop ports 70 and add ports 72, respectively, with a fibre grating 74 placed between the circulators. The fibre grating 74 is a reflection grating which reflects all the wavelengths to be dropped/added at this access node (via the optical circulators). It transmits all other wavelengths and thereby allows them to optically bypass the node 10. This configuration can be used to provision point-to-point services between selected nodes. It can also support a mixture of point-to-point and SDH/SONET services.

The protection provided by the architecture of the network 2 is significant in that by providing two digital and optical cross-connects with dual fibre loops 8 allows the network to continue to handle traffic if a single fibre cable breaks or a single node fails in a loop 8. In one configuration, the communications and protection traffic travel in opposite directions on separate fibres and are routed by separate respective routers 4. The optical path only ever travels through one optical router 4, and there is no fibre link between the routers 4. In a second configuration, there is a fibre link between the optical routers 4, but the optical routers are configured such that the inter-ring traffic avoids the link between the two optical cross-connects 4 and the associated losses. The inter-ring traffic can be considered to be routed on the outer ring circumference. Only the intra-ring traffic uses the fibre link between the two optical routers 4 in some instances, for example for protection traffic. In this configuration each router 4 carries both communications and protection traffic, with each one carrying respective halves of the communications and the protection traffic. The inter-ring traffic only passes through one router 4.

The distance covered by the passive architecture of the network 2 can be extended, if necessary, by adding optical amplifiers to the output ports 32 to 40. Optical amplifiers 80 can also be added to the add and drop ports 70, 72, as shown in FIG. 8.

The architecture of the network 2 is particularly advantageous as it reduces the switching load on the digital cross-connects 6 whilst also reducing the size of, and the losses experienced in the local loops 8. Adding the optical cross-connects 4 and the WDM interconnection architecture allows direct optical interconnection between any two nodes 10 within a metropolitan area. The need for intermediate optical-electrical-optical conversion is obviated. The architecture also allows increased traffic demand to be easily catered for by simply allocating additional channels in a transmission band, which may involve using the fsr of the AWG. This removes the requirement to add an additional loop to cater for the increased demand. The architecture also provides advantageous protection against failure in a link or node.

Many modifications will be apparent to those skilled in the art without departing from the scope of the present invention as herein described with reference to the accompanying drawings.

1. A communications network, including:
a plurality of optical fibre loops each having respective access nodes included in the loops, an optical wavelength group for traffic within the loop, and at least one other optical wavelength group for traffic to at least one other loop; and
an optical cross-connect for routing traffic between the loops by selecting said wavelength groups.

2. A communications network as claimed in claim 1, wherein said optical cross-connect is passive.

3. A communications network as claimed in claim 1, wherein the groups include wavelength bands having distinct wavelength channels.

4. A communications network as claimed in claim 3, wherein the bands are continuous bands.

5. A communications network as claimed in claim 3, wherein the bands include a periodic series of wavelength channels.

6. A communications network as claimed in claim 1, wherein inter-loop traffic between nodes on different loops is allocated a channel in said at least one other wavelength group.

7. A communications network as claimed in claim 6, wherein intra-loop traffic between nodes on a loop is allocated a channel in said wavelength group for traffic within the loop.

8. A communications network as claimed in claim 1, wherein the network reuses the wavelength groups, and the number of wavelength groups of the network is equal to the number of optical loops.

9. A communications network as claimed in claim 1, having full connectivity with each optical path traversing at most two loops and said optical cross-connect.

10. A communications network as claimed in claim 1, wherein the loops support WDM communications signals and the network has at least one hub node provided by the optical cross-connect and the access nodes each include an optical add-drop multiplexer.

11. A communications network as claimed in claim 1, wherein the loops each include at least two optical fibres and the network has at least two of said optical cross-connect for said fibres, respectively.

12. A communications network as claimed in claim 1, wherein the loops each include at least two optical fibres and the network has at least two of said optical cross-connect connected by an optical fibre link.

13. A communications network as claimed in claim 11, wherein one of said optical cross-connects and one of said fibres is for optical protection in the event of a failure in the network.

14. A communications network as claimed in claim 12, wherein one of said fibres is for protection traffic and fibres for protection traffic and communications traffic are connected to both of the optical cross-connects and inter-loop traffic uses one of said optical cross-connects.

15. A communications network as claimed in claim 1, including an electronic cross-connect connected to the optical cross-connect for switching traffic to other networks.

16. A communications network as claimed in claim 11, including electronic cross-connects connected to the optical cross-connects, respectively, for switching traffic to other networks.

17. A communications network as claimed in claim 16, wherein said network is a metropolitan area network.

18. A communications network as claimed in claim 1, wherein the optical cross-connect is an Arrayed Waveguide Grating (AWG).

19. A communications network as claimed in claim 18, wherein at least one of said wavelength groups includes channels separated by the free spectral range of the AWG.

20. A communications network as claimed in claim 1, wherein the optical cross-connect is a N×N interconnection of optical multiplexer and demultiplexer pairs.

21. A communications network as claimed in claim 20, wherein optical multiplexers and optical demultiplexers of the network comprise an AWG.
